(19) United States
(12) Patent Application Publication
(10) Pub. No.: US 2015/0373503 A1
(43) Pub. Date: Dec. 24, 2015

(54) METHOD AND APPARATUS FOR POSITIONING SYSTEM ENHANCEMENT WITH VISIBLE LIGHT COMMUNICATION

(71) Applicant: QUALCOMM Incorporated, San Diego, CA (US)

(72) Inventor: Aleksandar Jovicic, Jersey City, NJ (US)

(21) Appl. No.: 14/311,190

(22) Filed: Jun. 20, 2014

(51) Int. Cl. H04W 4/04; H04B 10/116

(52) U.S. Cl. CPC H04W 4/04; H04B 10/116

(57) ABSTRACT

Method, mobile device, computer program product, and apparatus for performing Positioning System Enhancement is described. A visible light communication (VLC) signal is received at a mobile device in an environment and the mobile device measures an external field in response to receiving the VLC signal. The mobile device decodes an identifier from the VLC signal and determines a relative position to the VLC signal source. The mobile device sends information to a server. The information sent to the server includes the identifier, position, and external field measurement. The server calculates position within the heatmap according to the identifier and relative position received from the mobile device. The server updates the heatmap according to the position of the mobile device and respective external measurements at the position.

### FIELD

The subject matter disclosed herein relates generally to radio frequency and magnetic field calibration, positioning, and optimization.

### BACKGROUND

Device positioning can be useful for a number of applications, such as navigating mobile phone users in office or commercial environments, enabling customers to find items in a supermarket or retail outlet, coupon issuance and redemption, customer service and accountability, or other consumer applications. However, estimating position can be difficult, especially indoors where satellite based positioning may be unavailable. Indoor positioning is typically achieved using radio frequency (RF) signals received from Wi-Fi access points (or similar means). However, this technique requires mobile devices to reference RF signal propagation parameters for a particular location, which presents a significant technical challenge for achieving accurate fine grain results (e.g., within one meter).

RF positioning systems based on signal fingerprinting (e.g., RF signal matching), typically rely on fingerprint prediction. Fingerprint prediction can include predicting what RF signals will be detectable at a particular location. The signal prediction may be represented using a map of the geographic region over which the positioning system operates. The map may contain information describing the spatial (e.g., positional) variation of the physical characteristics of the signal(s) that constitute the fingerprint, or some portion thereof. Accuracy of the position estimate produced by a positioning algorithm using a heatmap (e.g., prediction map, or signal heatmap) can depend upon the accuracy of the underlying RF parameters to create the map.

Fingerprints may be obtained using parametric models of the propagation of the physical signal used by the positioning system. For example, in the case of RF signal based positioning, a ray-tracing algorithm may be used to compute an estimate of received signal power or signal propagation time for a given transmit location. In an indoor environment, (e.g., inside a building or venue), the propagation predicted by the ray-tracing algorithm may depend on a number of parameters, such as the RF properties of the wall, ceiling, or floor materials, including reflection, refraction, and diffraction effects. One problem with using a parametric model based approach to generating fingerprints is that the reliability of the map depends on the accuracy of the parameters used in generating the map. Parameters may be based on an initial RF signal survey made at a point in time or over some time period. After the survey is completed RF signal or sources physical conditions may change, affecting RF signal propagation at one or more locations covered by fingerprints.

Additionally, RF signal surveys can be costly and/or impractical to perform. For example, to survey the RF infrastructure within a venue may involve specialized surveyors following detailed blueprints of the venue. While following the blueprints, the surveyors may take Wi-Fi positioning measurements from various locations within the venue. For example RF measurements may be a received signal strength indicator (RSSI) or round trip time (RTT) measurement. The surveyors take into account the physical location of the Wi-Fi access points by relying on detailed maps. This method does not scale well and is error prone. Furthermore, some RF infrastructure (e.g., Bluetooth devices) may be thrown about or placed in almost random locations within a venue (e.g., information displays within a store). The location of the Bluetooth devices may not be known to the venue's positioning server(s) while users are interacting with the Bluetooth devices. Due to the inaccuracy of RF signals, locating Bluetooth devices using traditional methods may be difficult or impractical. Therefore, there is a need for improved RF optimization techniques for use with Bluetooth, and Wi-Fi.

### SUMMARY

Embodiments disclosed herein may relate to a method for positioning system enhancement. In one embodiment, the method receives a visible light communication (VLC) signal at a mobile device and decodes an identifier from the received VLC signal. The method further determines a position of the mobile device relative to a source of the VLC signal and measures an external field in response to receiving the VLC signal, where the external field is at least one of magnetic or electromagnetic, and where the external field measurement is associated with the position of the mobile device. The method also sends information to a server, the information including the identifier, the position, and the external field measurement associated with the position of the mobile device.

Embodiments disclosed herein may relate to mobile device comprising hardware and software to perform positioning system enhancement. In one embodiment, the mobile device receives a VLC signal at a mobile device and decodes an identifier from the received VLC signal. The mobile device further determines a position of the mobile device relative to a source of the VLC signal and measures an external field in response to receiving the VLC signal, where the external field is at least one of magnetic or electromagnetic, and where the external field measurement is associated with the position of the mobile device. The mobile device also sends information to a server, the information including the identifier, the position, and the external field measurement associated with the position of the mobile device.

Embodiments disclosed herein may relate to a method for updating a heatmap at a server. In one embodiment, the method receives a position of a mobile device relative to a source of a VLC signal, an identifier for the source of the VLC signal, and an external field measurement captured at the position of the mobile device relative to the source of the VLC signal, where the external field is at least one of magnetic or electromagnetic. The method also identifies a position in the heatmap according to the identifier for the source of the VLC signal and the position of the mobile device relative to the source of the VLC signal and updates, according to the received the external field measurement, one or more positioning parameters associated with the identified location in the heatmap.

Embodiments disclosed herein may relate to a server comprising hardware and software to perform positioning system enhancement. In one embodiment, the server receives a position of a mobile device relative to a source of a VLC signal, an identifier for the source of the VLC signal, and an external field measurement captured at the position of the mobile device relative to the source of the VLC signal, where the external field is at least one of magnetic or electromagnetic. The server also identifies a position in the heatmap according to the identifier for the source of the VLC signal and the position of the mobile device relative to the source of the VLC signal and updates, according to the received the external field measurement, one or more positioning parameters associated with the identified location in the heatmap.

Other features will be apparent from the accompanying drawings and from the detailed description.

### BRIEF DESCRIPTION OF THE DRAWINGS

FIG. 1 illustrates a wireless communications operating environment for performing Positioning System Enhancement, in one embodiment;

FIG. 2 is a flow diagram illustrating a method for performing Positioning System Enhancement, in one embodiment;

FIG. 3 is a flow diagram illustrating a method for performing Positioning System Enhancement implemented by a mobile device, in one embodiment;

FIG. 4 is a flow diagram illustrating a method for performing Positioning System Enhancement implemented by a server, in one embodiment;

FIG. 5 is block diagram illustrating an exemplary device in which embodiments of Positioning System Enhancement may be performed; and

FIG. 6 is block diagram illustrating an exemplary server in which embodiments of Positioning System Enhancement may be performed.

### DESCRIPTION

The terminology used herein is for the purpose of describing particular embodiments only and is not intended to be limiting of embodiments of the aspects or features described herein. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

Further, many embodiments are described in terms of sequences of actions to be performed by, for example, elements of a computing device (e.g., a server or device). It will be recognized that various actions described herein can be performed by specific circuits (e.g., application specific integrated circuits), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the described herein may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

In one embodiment, Positioning System Enhancement (PSE), as described herein, leverages Visible Light Communication (VLC) to determine fast, accurate, on the fly positioning of a device. In one embodiment, the positioning determined by VLC is used to increase the speed and accuracy of a radio frequency (RF) positioning infrastructure within a venue. RF parameters associated with locations in a venue may be refined with the VLC positioning information. Devices lacking VLC capability can reference the updated RF parameters and benefit from optimized positioning. Furthermore, by refining the RF parameters and updating a heatmap, device positioning accuracy is increased for locations beyond the locations with a VLC installation.

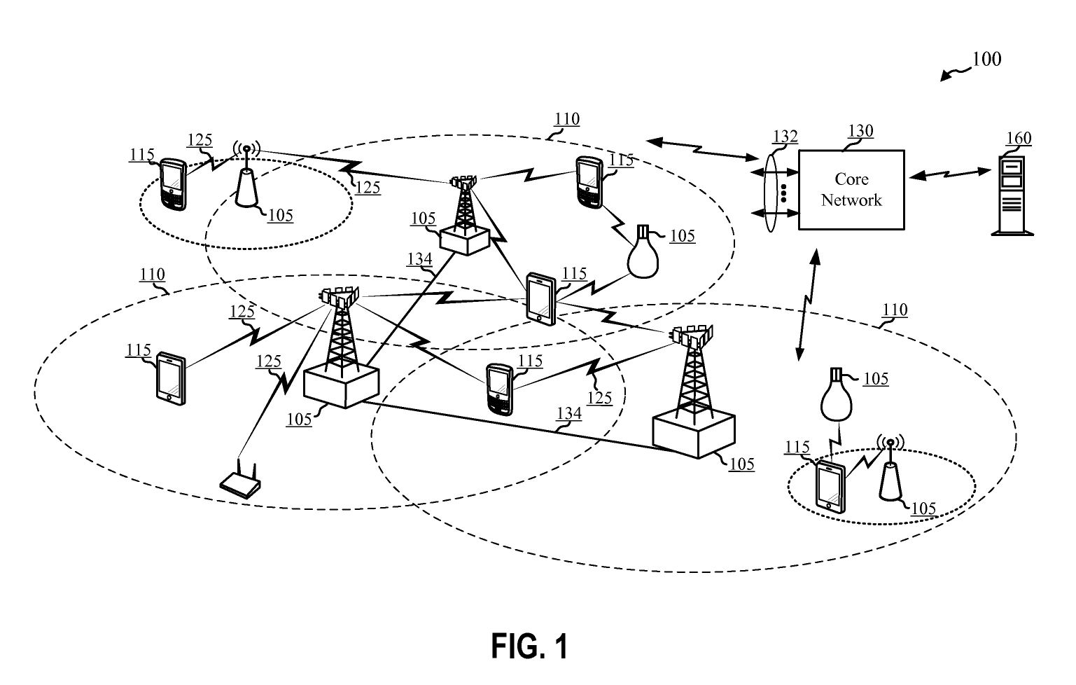

FIG. 1 illustrates a wireless communications operating environment for performing Positioning System Enhancement, in one embodiment. The system 100 includes a plurality of access points (e.g., base stations, eNBs, or WLAN access points) 105, server 160 (e.g., a positioning server), a number of mobile devices 115, and a core network 130. Some of the access points 105 may communicate with the mobile devices 115 under the control of the positioning server, which may be part of the core network 130 or certain access points 105 (e.g., base stations or eNBs) in various embodiments. Positioning requests may originate from mobile devices 115 and may be sent to the positioning server which may in turn send a request to an access point within range of the mobile device. Some of the access points 105 may communicate control information and/or user data with the core network 130 through backhaul 132. In some embodiments, some of the access points 105 may communicate, either directly or indirectly, with each other over backhaul links 134, which may be wired or wireless communication links. The system 100 may support operation on multiple carriers (waveform signals of different frequencies). Multi-carrier transmitters can transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, etc.

The access points 105 may wirelessly communicate with the mobile devices 115 via one or more access point antennas. Each of the access points 105 may provide communication coverage for a respective geographic area 110. In some embodiments, an access point 105 may be referred to as a base station, a base transceiver station (BTS), a radio base station, a radio transceiver, a basic service set (BSS), an extended service set (ESS), a NodeB, an evolved NodeB (eNB), a Home NodeB, a Home eNodeB, a WLAN access point, or some other suitable terminology. The coverage area 110 for an access point may be divided into sectors making up only a portion of the coverage area (not shown). The system 100 may include access points 105 of different types (e.g., macro, micro, and/or pico base stations). The access points 105 may also utilize different radio technologies. The access points 105 may be associated with the same or different access networks. The coverage areas of different access points 105, including the coverage areas of the same or different types of access points 105, utilizing the same or different radio technologies, and/or belonging to the same or different access networks, may overlap.

In some embodiments, the system 100 may include an LTE/LTE-A communications system (or network). In LTE/LTE-A communications systems, the term evolved Node B (eNB) may be generally used to describe one of the access points 105 and the term user equipment (UE) may be generally used to describe one of the mobile devices 115. The system 100 may also be a Heterogeneous LTE/LTE-A network in which different types of eNBs provide coverage for various geographical regions. For example, each eNB 105 may provide communication coverage for a macro cell, a pico cell, a femto cell, and/or other types of cell.

The core network 130 may communicate with the eNBs 105 via a backhaul 132 (e.g., S1, etc.). The eNBs 105 may also communicate with one another, e.g., directly or indirectly via backhaul links 134 (e.g., X2, etc.) and/or via backhaul 132 (e.g., through core network 130). The wireless communications system 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for either synchronous or asynchronous operations.

The mobile devices 115 may be dispersed throughout the wireless communications system 100, and each mobile device 115 may be stationary or mobile. A mobile device 115 may also be referred to by those skilled in the art as a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A mobile device 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A mobile device may be able to communicate with macro eNBs, pico eNBs, femto eNBs, relays, and the like. A mobile device may also be able to communicate over different access networks, such as cellular, Wireless Wide Area Network (WWAN), or Wireless Local Area Network (WLAN).

The communication links 125 shown in system 100 may include uplinks for carrying uplink (UL) transmissions (e.g., from a mobile device 115 to an eNB 105) and/or downlinks for carrying downlink (DL) transmissions (e.g., from an eNB 105 to a mobile device 115). The UL transmissions may also be called reverse link transmissions, while the DL transmissions may also be called forward link transmissions.

A mobile device 115 can receive information-carrying light signals, such as VLC signals or infrared signals. When illuminated by a light source 105 capable of transmitting an information-carrying light signal, the mobile device 115 may receive and decode the light signal to obtain identification information for the light source 105. The identification information contained in the light signal may in some cases include a repeated codeword, such as a Media Access Control (MAC) address that uniquely identifies the light source 105 that transmitted the light signal or a less unique codeword that identifies the light source 105 within a particular context (e.g., within a particular building). The identification information may enable the mobile device 115 to determine the location of the light source 105 (e.g., by looking up the location in a database). In other cases, the identification information may contain a description of the location of the light source 105. The location of the light source 105 may be an absolute location (e.g., a latitude and longitude) or may be specified relative to a reference or venue (e.g., relative to a building). By identifying the angle of arrival of the light signal, the mobile device 115 may be able to determine positioning information based on the light signal. In some cases, the positioning information may include a direction of one or more light sources 105 with respect to the mobile device 115. In some cases, the positioning information may also or alternately include an estimate of the distance from the mobile device 115 to one or more light sources 105. In some cases, the mobile device 115 may receive light signals from more than one light source 105.

In addition to VLC signals, mobile device 115 can also determine position based on network or mobile based positioning. PSE can determine a device's position based on a heatmap with signal measurement (e.g., RF signal classification/measurement, and/or magnetic field classification/measurement). The heatmap may be created using determined positioning parameters as described herein. In one embodiment, positioning parameters include RF parameters such as one or more of: a tap delay (e.g., the delay with which a collection of signal paths from the transmitter arrive at the receiver), wall loss parameter, a path loss exponent parameter, a diffraction parameter, body (e.g., object or person) loss, and transmission power of a device transmitting the RF signal (e.g., RF signal source).

In one embodiment, the RF parameters includes statistics associated with received RF signal power at the determined location. For example, the RF parameter that is configured can be the expectation (mean) of the signal power that (another) mobile device would expect to experience at the determined location. The RF parameter may also be the variance, or any other moment or statistical description, of the received signal power. In one embodiment, the positioning parameter associated with the received RF signal power can be used to create or update the heatmap. For example, a probability density function with the configured RF parameters may be assigned to the determined location. In one embodiment, a mobile device determines position by evaluating all or some of the probability density functions in the heatmap with a received RF signal power measured by the mobile device. The best estimate of the position is the position at which the evaluated probability density function has the largest value out of all the probability density functions that were evaluated (e.g., “maximum a posteriori” estimation).

RF parameters may be updated or refined, as devices collect additional RF characteristics or measurements. For example, RF parameters, used in generating a heatmap, may be updated or configured based on measurements of a RF signal or signals, between a mobile device and an access point and precise positioning determined from a VLC signal. In some embodiments, the measured signals are peer to peer RF signals, communicated using a peer to peer signaling protocol. The updated set of RF parameters is used to generate a new or updated heatmap. The positioning server or a mobile device can reference the updated heatmap to enable precise RF signal based positioning.

RF signal measurements may include one, more, or all of: electromagnetic radiation signal measurements, acoustic signal measurements, RF spectrum signal measurements, microwave spectrum signal measurements, visible light spectrum signal measurements, and IR light spectrum signal measurements. In some embodiments, the signal measurements include a vector of measured signals of different types. In some embodiments, the signal measurements include one or more results determined from different signal characteristics. For example, measured signal characteristics may include received signal power level (e.g., RSSI), time delay (e.g., RTT), frequency, or delay-spread.

PSE may be implemented as software, firmware, hardware, module, or engine of a device (e.g., mobile device 115) and/or server (positioning server 160). In some embodiments PSE performs on, or is integrated into both a mobile device and server. In some embodiments, aspects of PSE may be performed by a wireless AP within the environment. For example, the wireless AP may measure RF signals received from the mobile device.

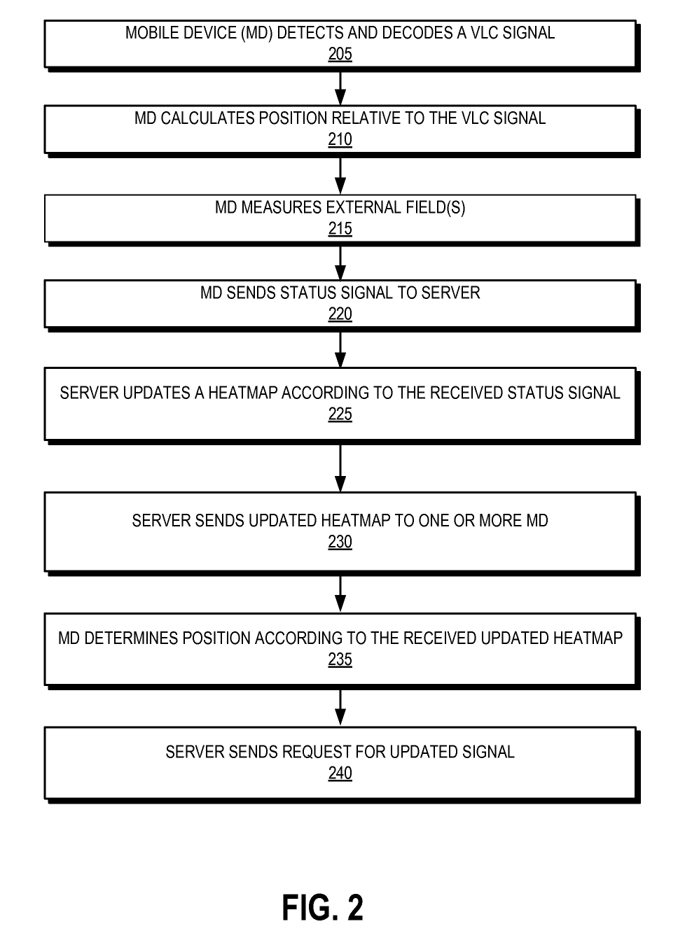

FIG. 2 is a flow diagram illustrating a method for performing Positioning System Enhancement, in one embodiment. At block 205, the mobile device (e.g., PSE implemented on a mobile device) detects and decodes a VLC signal. For example, PSE on the mobile device can receive VLC signals within an environment. The VLC signals source may be one or more light fixtures/emitters (e.g., ceiling mounted or installed in such a way to reach mobile devices within the environment such as emitter 105). A camera/image sensor (e.g., camera 570) on a mobile device (e.g., the mobile device 115) may capture the VLC signal (e.g., light data) to determine the relative position from the device to the VLC signal source (e.g., the emitter or fixture). The VLC signals may carry identification (ID) messages for the particular source (e.g., a unique light fixture or emitter identifier). If the identifier is sent with a specific transfer protocol or format PSE can decode the VLC signal and store the identifier(s) at the mobile device. In response to detecting a VLC signal, the mobile device may notify a server of receipt of the VLC signal. In some embodiments, PSE decodes the ID messages at a server separate or remote from the mobile device. For example the raw received sensor data (e.g., light data), or a representation of the received sensor data is passed/forwarded to the server for processing.

At block 210, the mobile device (e.g., PSE on the mobile device) calculates position relative to the VLC signal source. PSE can calculate high accuracy position estimates based on a coordinate system such as “x” and “y” distances from the light fixtures' location in the x-y plane. Alternatively, the position results may be described in terms of angles of arrival of light from the fixture relative to the gravity vector. The VLC signals may be time stamped with time of arrival at the mobile device. In some embodiments, detection of the VLC signal used for positioning determination triggers measurement of one or more ambient external fields of the mobile device. The measurement may be concurrently with receipt or detection of the VLC signal detected at block 205. In other embodiments, the external field measurement may occur at a later time provided the mobile device maintains a similar (e.g., within a threshold distance) position as that calculated from the VLC signal.

At block 215, the mobile device (e.g., PSE on the mobile device) measures external field(s). For example, an external field may be an RF electromagnetic signal and/or a magnetic field. In one embodiment, PSE associates or links RF, magnetic fields, and VLC signals when the external field(s) are detected/arrive at roughly the same time (e.g., within a same time window or period). The measurement of one or more external field(s) may be time stamped with time of arrival at the mobile device and associated with VLC signals obtained at approximately the same time (e.g., within a defined time window threshold). RF electromagnetic signals measured by the device may originate from Wi-Fi access points, Bluetooth transmitters, small cell signals, or other RF signal sources. The actual location of an RF signal sender/source may or may not be known to PSE and the receiving device when the signal arrives and before processing of the signal. In some embodiments, the mobile device may transmit an RF signal to a nearby AP in addition to or instead of the receiving RF signals. For example, a nearby AP may receive the RF signal from the mobile device and send a representation of the RF signal to a server for processing (e.g., RF parameter analysis for a heatmap).

In one embodiment, the external field comprises a magnetic field (e.g., an ambient magnetic field in the vicinity of the mobile device). In one embodiment, PSE associates or links magnetic field measurement and VLC signals at roughly the same time (e.g., concurrently or within a same time window or period). The magnetic field measurement may also be time stamped with time of arrival at the mobile device and associated with VLC signals obtained at approximately the same time (e.g., within a defined time window threshold).

At block 220, the mobile device (e.g., PSE on the mobile device) sends a status signal to a server. In one embodiment, the status signal includes one or more of the decoded identifier from the VLC signal, the relative position of the mobile device to the VLC signal source, and external field measurements described above. For example, the status signal can include location and positioning information determined with respect to the magnetic field, RF signal, and VLC signal. The status signal can include the decoded ID messages of the light fixtures from the VLC signals and the computed position of the device relative to the light fixtures, or angles of arrival. The status signal can also include representations of RF signals, RF identifiers, received VLC signals, or magnetic field measurements (e.g., as captured by the mobile device). The status signal may also include the corresponding IDs of the devices transmitting the received RF signals. The status signal may include determined physical characteristics of the RF signals instead of or in addition to a representation of the RF signal. For example, the external fields may be represented by numerical values, or an industry standard identification format. PSE can send a status signal using an RF channel on a wireless local area network or wide area network. In other embodiments, instead of sending the signal to a server, the device keeps the signal local to the device and updates positioning parameters locally on the device. The status signal may be a packaged combination of the identifier, position, and external field measurements. However, in some embodiments each component of the status signal may be transferred to a server separately or in other combinations. In some embodiments, the mobile device can transmit an RF signal to an AP within range of the mobile device, and the AP can send a representation of the RF signal to the server.

In one embodiment, the external fields and VLC signals are sent to the server with an associated time stamp to link the external field detection/collection and VLC to a particular time window. For example, PSE may determine a VLC signal and an external field (e.g., RF electromagnetic signal or magnetic field) captured within a second of each other are likely to have occurred at approximately the same position or location and can describe properties at that position or location. In some embodiments, PSE sends a paired or combined representation that comprises an external field and VLC signal associated with a location determined according mobile device distance calculated from the VLC signal.

At block 225, the server (e.g., PSE on the server) updates a heatmap according to the received status signal. The status signals may be RF signals sent by the mobile device or an AP that has received RF signals from the mobile device. In one embodiment, a heatmap describes the dependence of the measured RF or magnetic strength characteristics on position coordinates inside a location or venue. For example, the heatmap may contain RSSI, RTT, or ambient magnetic measurements at specific points within a coordinate map.

In one embodiment, PSE calculates an RF signal based estimation of the mobile device position from physical characteristics of received status signal, such as received RF signal power level or RSSI, RF signal path time delay, RF signal delay spread, RF signal frequency, or ambient magnetic field strength. PSE can match the physical characteristics of an external field against a pre-computed heatmap which describes the dependence of the physical characteristics on position coordinates inside a location or venue. In one embodiment PSE can compute desired physical characteristics of the received external field(s) and stores them at the server. The identification information of the transmitting device which it can obtain from the signal itself (such as the beacon signal in Wi-Fi) may also be stored at the server. The identification information can be a MAC address, for example, and PSE can link or associate the identification information with the physical characteristics. PSE can generate a new heatmap corresponding to the physical characteristics of the magnetic field, and/or RF signals at the VLC determined position.

In one embodiment, PSE processes the components of the status signal and updates the parameters of a heatmap (e.g., fingerprint, RF heatmap, magnetic field heatmap, or a combination thereof) that relates the physical characteristics of the RF signals or magnetic field with locations in the venue. In one embodiment, some of the parameters represent the location of the access points and PSE updates the parameters based upon the data from the received status signal. The parameters may represent RF propagation characteristics such as path loss, tap delay, wall loss, diffraction (e.g., diffraction coefficients), body loss (e.g., blocking from people within a venue or location), transmission power of the device transmitting the RF signal, and statistics of a strength of an ambient magnetic field at the mobile device's location. The parameters may be probabilistic and may be updated using Bayesian estimation methods such as Belief Propagation or the EM algorithm. The heatmap may describe the mean of the RF signal or magnetic strength as a function of location in the venue and may also include information about the locations of the access points. In other embodiments PSE may process the status signals and update the heatmap locally on the mobile device.

In one embodiment, PSE updates parameters associated with the heatmap of the environment or venue according to the position of the device when the external field measurements were obtained. For example, in response to determining the ID of the light fixture and the position of the device relative to that fixture (e.g., as determined above with respect to the decoded ID messages), PSE can reference a floor map with light fixture location information and the fixture's corresponding IDs. PSE can determine the best fit of a parameter set in response to computing the position of the mobile device and the physical characteristics of received representations of the external field(s). For example, the external field(s) (e.g., RF signals and/or magnetic field) received/detected within a time window surrounding the VLC signal capture may be associated with the location determined by the VLC signal. The best fit may be defined as the set of values of the set of parameters which best describe the given value of the physical characteristic of the external field(s) with respect to a chosen cost function. The cost function may be mean squared error or a posterior probability distribution. The underlying model which a line of sight model a diffracted path model to relate the parameters to the physical characteristics of the signal. For example, a line of sight model may have transmitted power and path loss as parameters, and a diffracted path model may have in diffraction losses as a parameter. The parameters may also describe the location of the access point which transmitted a respective RF signal.

At block 230, the server (e.g., PSE on the server) sends the updated heatmap to one or more mobile devices. The server may transmit updated heatmaps to devices requesting positioning information. The requesting devices may not be the same as the device to provide the signal(s) used to update the heatmap. For example, devices with VLC capabilities can contribute accurate positioning and external field(s) measurements to enhance positioning performance for all devices using positioning within the venue (e.g., devices connected to a positioning server with enhanced positioning).

At block 235, the mobile device (e.g., PSE implemented on a mobile device) determines position according to the received updated heatmap. For example, the server can leverage the updated heatmap and a new set of received external field(s) transmitted by a device for positioning. Positioning utilizing the updated heatmap may perform with higher accuracy than positioning performed prior to updating the heatmap. PSE can determine position of the device by leveraging positioning algorithms that utilize the physical characteristics of received signals or magnetic field, such as magnetic field strength, RF signal received signal strength indicator (RSSI) or RF signal round trip time (RTT). PSE can match the physical characteristics of a measurement against a pre-computed heatmap which describes the dependence of the physical characteristics on position coordinates inside a location or venue. In one embodiment, PSE computes desired physical characteristics of the received RF signals and stores them at the device or server. In one embodiment, PSE can obtain the identification information of the transmitting device from the signal itself (such as the beacon signal in Wi-Fi). The identification information may also be stored at the device or server. The identification information can be a MAC address, for example, and PSE can link or associate the identification information with the physical characteristics. In other embodiments, instead of processing the magnetic field measurements, RF, and VLC signals at the device, the raw unprocessed signals, or a representation of the signals and measurements are sent to a server for processing. In some embodiments, instead of or in addition to processing at the device, RF signals may be transmitted from the device (e.g., to an AP within range of the device) and processing (e.g., characteristic determination) of the RF signal received at the AP is performed at a server (e.g., positioning server 160).

At block 240, the server (e.g., PSE on the server) sends request for updated signal(s). In one embodiment, a crowd-sourced implementation of PSE automatically updates RF parameters and heatmaps (e.g., signal prediction Wi-Fi positioning models and Bluetooth locations) on the fly from a group of VLC enabled users (e.g., customers in a shopping mall, or other visitors to a venue). For example, the server may determine the heatmap has not been updated in a threshold amount of time and send out a request for a device to obtain new VLC and associated external field(s). PSE may initiate an update request if time expired since configuring the positioning parameter is past a threshold amount. PSE can also request RF and VLC updated signals if wireless APs and Bluetooth devices are relocated or added to the venue. Furthermore, the venue itself may undergo renovation or structural changes that may trigger requests for updated external field measurements. The server may also receive errors or complaints from one or more mobile devices in the environment and initiate a request to update the heatmap. Updated external field measurements can be incorporated into an updated heatmap as described above.

PSE can also assist in positioning or locating RF devices other than systems with mobile devices and Wi-Fi access points in unknown locations. For example, a venue or location may distribute a set of Bluetooth devices setup to receive user check-ins or provide product information. PSE can measure RF signals associated with the Bluetooth devices in order to populate a heatmap for the Bluetooth devices in the environment. PSE can also leverage VLC and RF measurements to determine locations of Bluetooth devices within the environment. For example, in response to determining positioning according to a VLC signal, the range measurement to a nearby Bluetooth signal may be calculated according to the received RF signals.

A device (e.g., mobile device 115) may receive information-carrying light signals from one or more light sources as well as RF signals and magnetic field measurements. The information-carrying light signals may take various forms, such as VLC signals or infrared signals transmitted by a light emitting diode (LED) or other luminaire capable of having its intensity modulated. Using, for example, an image sensor and orientation sensor of the mobile device, the mobile device may decode the light signals received from one or more light sources, identify an angle of arrival of the light signal received from each light source, and associate each angle of arrival with an identified light source. The angle of arrival of a modulated light signal received from an identified light source is one form of positioning information that may be determined.

RF signals and magnetic field measurements relating to positioning or location may also be determined. For example, when a mobile device receives modulated light signals from at least three light sources, the mobile device may use trilateration to determine the location of the mobile device. The positioning information determined by the mobile device may also include, for example, a distance of the mobile device from each of a number of light sources.

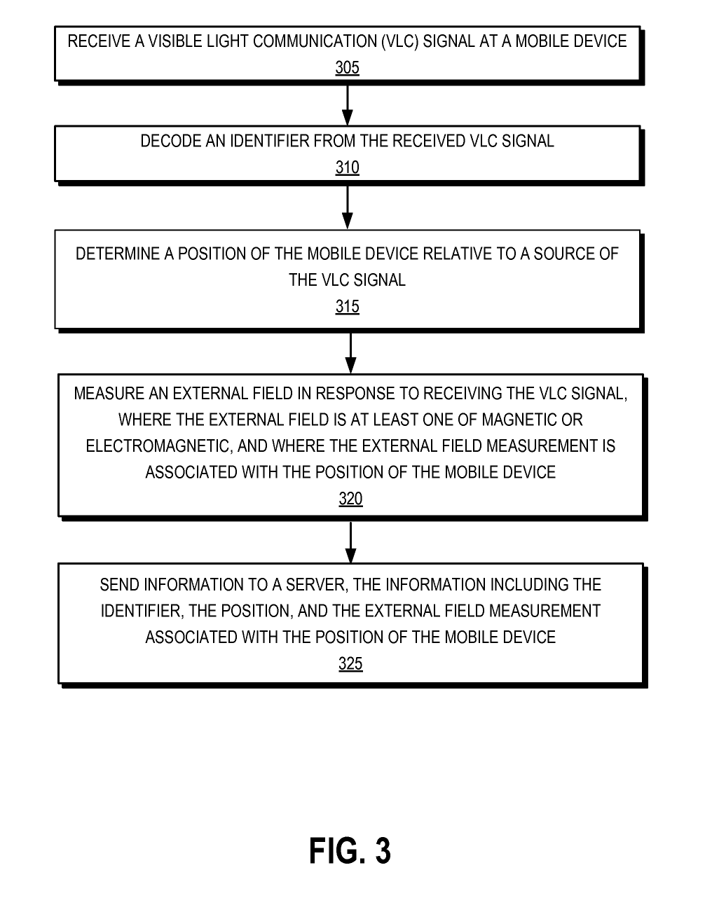

FIG. 3 is a flow diagram illustrating a method for performing Positioning System Enhancement implemented by a mobile device, in one embodiment. At block 305, the embodiment (e.g., PSE implemented with a mobile device 115) receives a VLC signal at a mobile device. For example, the mobile device may utilize integrated camera sensors to detect the light from the VLC signal source.

At block 310, the embodiment decodes an identifier from the received VLC signal. In one embodiment, the identifier is a unique code or description and may be used to determine the absolute position of the VLC source in a map. For example, a venue may associate each respective VLC emitter identifier with a specific coordinate location within the venue.

At block 315, the embodiment determines a position of the mobile device relative to a source of the VLC signal. PSE may analyze the VLC signal (e.g., light data) to determine the relative position or location of the device to the VLC signal source. At block 320, the embodiment measures an external field in response to receiving the VLC signal, where the external field is at least one of magnetic or electromagnetic, and where the external field measurement is associated with the position of the mobile device. In one embodiment, the external field is an electromagnetic RF signal and the mobile device receives the RF signal from a wireless AP or Bluetooth device. The mobile device may measure characteristics of the RF signal. For example, a characteristic of the RF signal may be related to received signal strength indication or signal power level, RF signal path time delay, RF signal delay spread, RF signal frequency, or other RF characteristic of the RF signal received at the mobile device. In some embodiments, the RF signal is transmitted from the mobile device to an AP, and the AP determines the RF characteristics. For example, a positioning server communicating with the AP can compute the positioning parameter(s) transmitted by the mobile device at the VLC verified position. For example, the VLC determined position and the characteristic (e.g., RF characteristics) may be time stamped at time of respective determination, and timestamps within a threshold time difference may be associated with each other.

In some embodiments, the mobile device may transmit an RF signal from to a wireless access point or a Bluetooth device. In response to receiving the RF signal the wireless access point or Bluetooth device may process the received RF signals to determine one or more RF signal measurements.

In one embodiment, the external field is a magnetic field and the mobile device measures characteristics (e.g., strength) of the magnetic field (e.g., an ambient magnetic field). In response to determining a respective magnetic field characteristic (e.g., strength measurement) at a VLC determined position, PSE can associate or link the position with the respective magnetic field characteristic. For example, the VLC determined position and the characteristic may be time stamped at time of respective determination, and timestamps within a threshold time difference may be associated with each other.

At block 325, the embodiment sends information to a server, the information including the identifier, the position, and the external field measurement associated with the position of the mobile device. In some embodiments, one or more of the components sent to the server are packaged as a status signal. In response to receiving the status signal and updating a heatmap, the server can return an updated heatmap. The updated heatmap can include improvements to the heatmap derived from the received status signal.

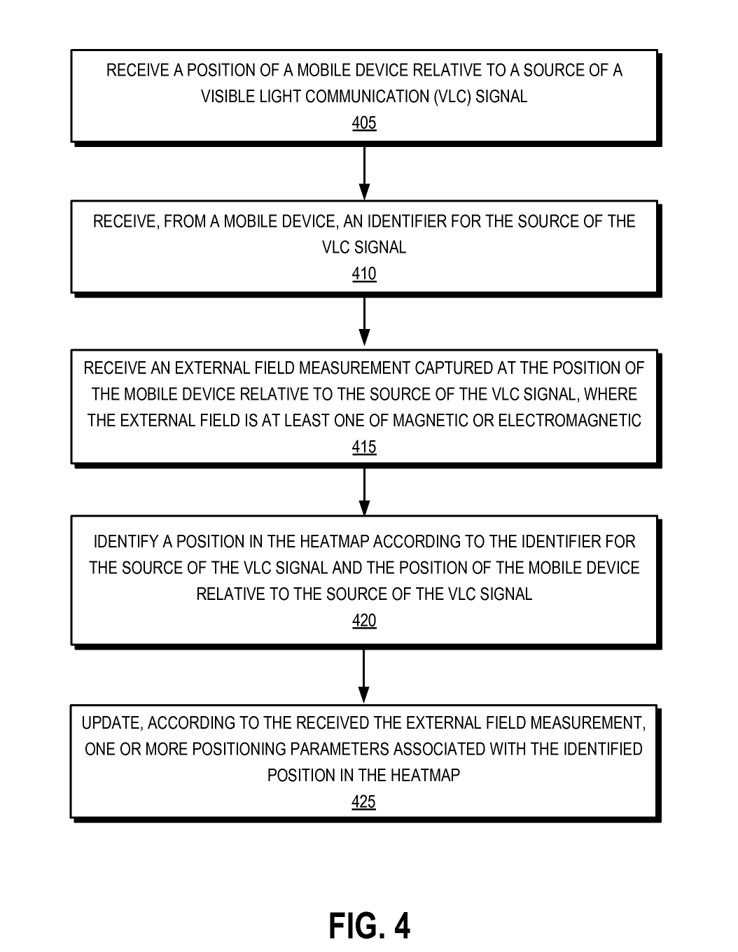

FIG. 4 is a flow diagram illustrating a method for performing Positioning System Enhancement implemented by a server, in one embodiment. At block 405, the embodiment (e.g., PSE implemented with server 160) receives a position of a mobile device relative to a source of a VLC signal. The position may be based on coordinate system having “x” and “y” distances from the VLC signal source (e.g., light fixtures′) location in the x-y plane. In some embodiments, the position may be an absolute position. For example, PSE may determine the relative position of the mobile device to the VLC signal source, and in response to identifying the VLC source in a map, calculate the position of the mobile device in the map.

At block 410, the embodiment receives, from a mobile device, an identifier for the source of the VLC signal. VLC signals may include embedded messages (e.g., an identifier) identifying the particular VLC signal source (e.g., a specific light fixture or emitter identification).

At block 415, the embodiment receives an external field measurement captured at the position of the mobile device relative to the source of the VLC signal, where the external field is at least one of magnetic or electromagnetic. For example, an external field may be an RF electromagnetic signal and/or a magnetic field as described above. In one embodiment, the external field measurement is captured at approximately the same time as the receipt of the VLC signals such that the position determination of block 405 also reflects the position of the mobile device while measuring the external field. In some embodiments, external field measurements occur concurrently (e.g., approximately at the same time) with the VLC based position determination, and the external field measurements are assumed to occur at the position determined from the VLC signals.

At block 420, the embodiment identifies a position in a heatmap according to the identifier for the source of the VLC signal and the position of the mobile device relative to the source of the VLC signal. PSE may determine the position in the heatmap by referencing the known position of the identified VLC emitter at the venue. For example the position in the heatmap may be an x-y coordinate position determined from calculating the distance observed by the mobile device to the specific VLC emitter identified in a coordinate map for the venue.

At block 425, the embodiment updates, according to the received the external field measurement, one or more positioning parameters associated with the identified position in the heatmap. In response to receiving determining the position of the external field measurement (e.g., the location where the mobile device observed and measured the external field in the environment or venue), PSE can optimize or enhance the performance of existing Wi-Fi (e.g., network based positioning) models or signal prediction heatmaps relating to physical characteristics of the external field(s) at the specified position.

PSE can generate (e.g., PSE at the positioning server) a new or updated heatmap corresponding to parameters derived from the status signal received from the mobile device. The positioning parameters may include path loss, tap delay, wall losses, diffraction coefficients, body losses, and transmission power of the device transmitting an RF signal. The positioning parameters may include statistics relating to strength of an ambient magnetic field at a mobile device's location. The positioning parameters may be probabilistic and may be updated using Bayesian estimation methods such as Belief Propagation or the EM algorithm. The heatmap may describe the mean of the RF signal strength or magnetic field as a function of location in the venue. In one embodiment, some of the positioning parameters represent the location of the access points or other information pertaining to the access points in a location. PSE can update the positioning parameters based upon the processing of the measured external field(s) characteristics. The updated heatmap may be distributed to mobile devices requesting a heatmap irrespective of whether the mobile devices contributed to the update of the heatmap. For example, devices lacking VLC positioning capabilities may still benefit from the improved heatmap.

Changes may be made in the function and arrangement of elements discussed in FIGS. 2-4 without departing from the spirit and scope of the disclosure. Various embodiments may omit, substitute, or add various procedures or components as appropriate. For instance, the methods described in FIGS. 2-4 may be performed in an order different from that described, and various steps may be added, omitted, or combined. Also, features described with respect to certain embodiments may be combined in other embodiments.

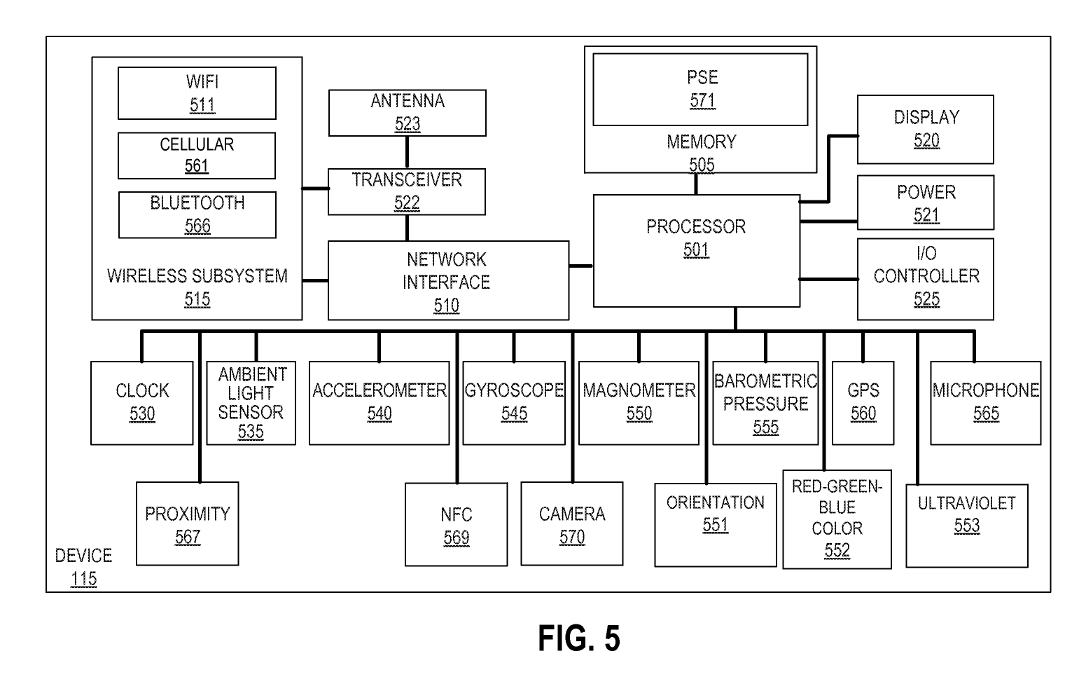

FIG. 5 is block diagram illustrating an exemplary device in which embodiments of Positioning System Enhancement may be performed. The system may be a device (e.g., the device 115), which may include one or more processors 501, a memory 505, I/O controller 525, and network interface 510. Device 115 may also include a number of device sensors coupled to one or more buses or signal lines further coupled to the processor 501. It should be appreciated that device 115 may also include a display 520, a user interface (e.g., keyboard, touch-screen, or similar devices), a power device 521 (e.g., a battery), as well as other components typically associated with electronic devices. In some embodiments, device 115 may be a mobile or non-mobile device.

The device (e.g., device 115) can include sensors such as a clock 530, ambient light sensor (ALS) 535, accelerometer 540, gyroscope 545, magnetometer 550, orientation sensor 551, barometric pressure sensor 555, red-green-blue (RGB) color sensor 552, ultra-violet (UV) sensor 553, UV-A sensor, UV-B sensor, compass, proximity sensor 567, near field communication (NFC) 569, and/or Global Positioning Sensor (GPS) 560. As used herein the microphone 565, camera 570, and/or the wireless subsystem 515 (Bluetooth 566, Wi-Fi 511, cellular 561) are also considered sensors used to analyze the environment (e.g., position) of the device. In some embodiments, multiple cameras are integrated or accessible to the device. For example, a mobile device may have at least a front and rear mounted camera. In some embodiments, other sensors may also have multiple installations or versions.

Memory 505 may be coupled to processor 501 to store instructions for execution by processor 501. In some embodiments, memory 505 is non-transitory. Memory 505 may also store one or more models or modules to implement embodiments described below. Memory 505 may also store data from integrated or external sensors. In addition, memory 505 may store application program interfaces (APIs) for accessing Positioning System Enhancement (PSE). In some embodiments, PSE functionality can be implemented in memory 505. In other embodiments, PSE functionality can be implemented as an independent module separate from other elements in the device 115. A PSE module may be wholly or partially implemented by other elements illustrated in FIG. 5, for example in the processor 501 and/or memory 505, or in one or more other elements of the device 115.

Network interface 510 may also be coupled to a number of wireless subsystems 515 (e.g., Bluetooth 566, Wi-Fi 511, Cellular 561, or other networks) to transmit and receive data streams through a wireless link to/from a wireless network, or may be a wired interface for direct connection to networks (e.g., the Internet, Ethernet, or other wireless systems). The mobile device may include one or more local area network transceivers connected to one or more antennas. The local area network transceiver comprises suitable devices, hardware, and/or software for communicating with and/or detecting signals to/from WAPs, and/or directly with other wireless devices within a network. In one aspect, the local area network transceiver may comprise a Wi-Fi (802.11x) communication system suitable for communicating with one or more wireless access points.

The device 115 may also include one or more wide area network transceiver(s) that may be connected to one or more antennas. The wide area network transceiver comprises suitable devices, hardware, and/or software for communicating with and/or detecting signals to/from other wireless devices within a network. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 4G, or GSM. Additionally, any other type of wireless networking technologies may be used, for example, WiMax (802.16), Ultra Wide Band, ZigBee, wireless USB, etc. In conventional digital cellular networks, position location capability can be provided by various time and/or phase measurement techniques. For example, in CDMA networks, one position determination approach used is Advanced Forward Link Trilateration (AFLT). Using AFLT, a server may compute its position from phase measurements of pilot signals transmitted from a plurality of base stations.

Thus, device 115 may be a: mobile device, wireless device, cellular phone, personal digital assistant, mobile computer, wearable device (e.g., head mounted display, wrist watch, virtual reality glasses, etc.), internet appliance, gaming console, digital video recorder, e-reader, robot navigation system, tablet, personal computer, laptop computer, or any type of device that has processing capabilities. As used herein, a mobile device may be any portable, or movable device or machine that is configurable to acquire wireless signals transmitted from, and transmit wireless signals to, one or more wireless communication devices or networks. Thus, by way of example but not limitation, the device 115 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at the device 115. Also, “mobile device” is intended to include all devices, including wireless communication devices, computers, laptops, etc. which are capable of communication with a server, such as via the Internet, Wi-Fi, or other network, and regardless of whether satellite signal reception, assistance data reception, and/or position-related processing occurs at the device, at a server, or at another device associated with the network. Any operable combination of the above are also considered a “mobile device.”

The mobile device may communicate wirelessly with a plurality of WAPs using RF signals (e.g., 2.4 GHz, 3.6 GHz, and 4.9/5.0 GHz bands) and standardized protocols for the modulation of the RF signals and the exchanging of information packets (e.g., IEEE 802.11x). By extracting different types of information from the exchanged signals, and utilizing the layout of the network (i.e., the network geometry) the mobile device may determine position within a predefined reference coordinate system.

The device 115 may include one or more antenna(s) 523 and a transceiver 522. The transceiver 522 may be configured to communicate bidirectionally, via the antenna(s) 523 and/or one or more wired or wireless links, with one or more networks, as described above. For example, the transceiver 522 may be configured to receive transmissions from one or more light sources 105 of FIG. 1, 2, and/or 3. The transceiver 522 may allow transmission and reception of data between the device 115 and one or more remote devices, such as one or more of the light sources 105. For example, the transceiver 522 may enable the device 115 to receive VLC signals from one or more remote light sources 105. The VLC signals may in some cases be received via an image sensor such as a CMOS image sensor. In some embodiments, the image sensor may be a part of the transceiver 522. Also, and by way of example, the transceiver 522 may enable the device 115 to receive data and/or control signals from an access point, such as one of the access points 105 described with reference to FIG. 2. By way of further example, the transceiver 522 may enable the device 115 to transmit data and/or control signals to an access point 105 or another device.

In one configuration, the transceiver 522 may include a modem configured to modulate packets and provide the modulated packets to the antenna(s) 523 for transmission, and to demodulate packets received from the antenna(s) 523. While the device 115 may include a single antenna, the device 115 may typically include multiple antennas 523 for multiple links.

It should be appreciated that embodiments described herein may be implemented through the execution of instructions, for example as stored in the memory 505 or other element, by processor 501 of device and/or other circuitry of device and/or other devices. Particularly, circuitry of device, including but not limited to processor 501, may operate under the control of a program, routine, or the execution of instructions to execute methods or processes in accordance with embodiments described herein. For example, such a program may be implemented in firmware or software (e.g. stored in memory 505 and/or other locations) and may be implemented by processors, such as processor 501, and/or other circuitry of device. Further, it should be appreciated that the terms processor, microprocessor, circuitry, controller, etc., may refer to any type of logic or circuitry capable of executing logic, commands, instructions, software, firmware, functionality and the like. The functions of each unit or module within the device 115 may also be implemented, in whole or in part, with instructions embodied in a memory, formatted to be executed by one or more general or application-specific processors. Each of the noted modules may be a means for performing one or more functions related to operation of the device 115.

Further, it should be appreciated that some or all of the functions, engines or modules described herein may be performed by device itself and/or some or all of the functions, engines or modules described herein may be performed by another system connected through I/O controller 525 or network interface 510 (wirelessly or wired) to device. Thus, some and/or all of the functions may be performed by another system and the results or intermediate calculations may be transferred back to device. In some embodiments, such other device may comprise a server (e.g., server 160) configured to process information in real time or near real time. Further, one or more of the elements illustrated in FIG. 5 may be omitted from the device 115. For example, one or more of the sensors 530-565 may be omitted in some embodiments.

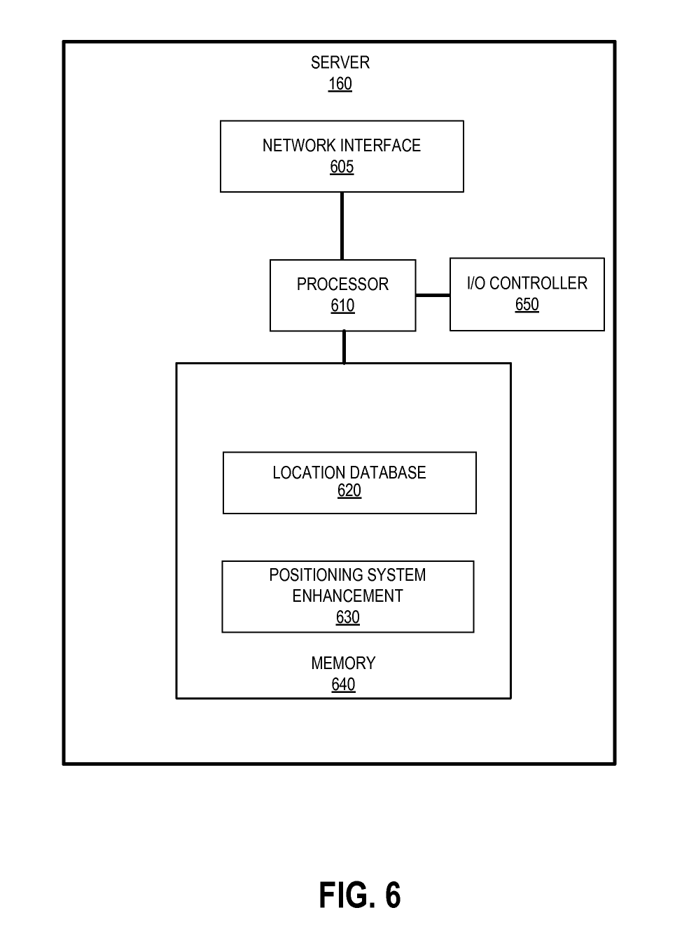

FIG. 6 is block diagram illustrating an exemplary server 160 in which embodiments of Positioning System Enhancement may be performed. For the sake of simplicity, the various features and functions illustrated in the box diagram of FIG. 6 are connected together using a common bus meant to represent that these various features and functions are operatively coupled together. Those skilled in the art will recognize that other connections, mechanisms, features, functions, or the like, may be provided and adapted as necessary to operatively couple and configure a data processing system (e.g., server 160). Further, it is also recognized that one or more of the features or functions illustrated may be further subdivided or combined.

The server 160 may include a network interface 610 configured to communicate with a network (e.g., wireless communication system 100), which may be configured to enable communication between servers (e.g., 160), and devices (e.g., mobile device 115).

A processor 610 may be connected to the network interface 605, and the memory 640. The processor may include one or more microprocessors, microcontrollers, and/or digital signal processors that provide processing functions, as well as other calculation and control functionality. The memory 640 can store data and software instructions for executing programmed functionality within the server. The memory 640 may be on-board the processor 610 (e.g., within the same IC package), and/or the memory may be external memory to the processor and functionally coupled over a data bus. The details of software functionality associated with aspects of the disclosure will be discussed in more detail below.

A number of software modules or data tables may reside in memory 640 and be utilized by the processor 610 in order to manage communications, and PSE functionality. As illustrated in FIG. 6, memory 640 may include location database 620 containing RF parameters, signal maps, and wireless access point locations. Memory 640 may also include PSE 630 to implement the features described herein, at least including some of the features of FIGS. 2, 3, and 4. One should appreciate that the organization of the memory contents as shown in FIG. 6 is merely exemplary, and as such the functionality of the modules and/or data structures may be combined, separated, and/or be structured in different ways depending upon the implementation of the mobile device. In one embodiment, PSE 630 is a process running on the processor 610 of the server 160 to provide optimized positioning and location information.

The server may optionally store auxiliary position/motion data in memory that may be derived from information received from various sources at the device 115 as described herein. Moreover, in other embodiments, supplemental information may include, but not be limited to, information that can be derived or based upon Bluetooth signals, beacons, RFID tags, and/or information derived from a map (e.g., receiving coordinates from a digital representation of a geographical map by, for example, a user interacting with a digital map).

Processor 610 may include any form of logic suitable for performing at least the techniques provided herein. For example, processor 610 may be operatively configurable based on instructions in memory 640 to selectively initiate one or more routines that exploit motion data for use in other portions of the mobile device.

The server may include an input/output controller 650 to provide any suitable interface systems, such as a microphone/speaker, keypad, and display that allows for local input to the server.

PSE may be implemented as software, firmware, hardware, module, or engine. In one embodiment, the above PSE description may be implemented by one or more general purpose processors (e.g., processor 501) in memory 505 of device 115 to achieve the previously desired functions (e.g., the methods of FIGS. 2 and 3). In another embodiment, PSE is partially implemented by one or more general purpose processors (e.g., processor 610) in memory 640 of server 160 to achieve one or more of the previously desired functions (e.g., the methods of FIGS. 2 and 4).

The teachings herein may be incorporated into (e.g., implemented within or performed by) a variety of apparatuses (e.g., devices). For example, one or more aspects taught herein may be incorporated into a phone (e.g., a cellular phone), a personal data assistant, a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a server, a point-of-sale device, an entertainment device, a set-top box, or any other suitable device. These devices may have different power and data requirements and may result in different power profiles generated for each interest point or set of interest points.

In some aspects a wireless device may comprise an access device (e.g., a Wi-Fi access point) for a communication system. Such an access device may provide, for example, connectivity to another network through a transceiver (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the aspects or features described herein.

The various illustrative logical blocks, modules, and circuits described in connection with the embodiments disclosed herein may be implemented or performed with a data processing device. The data processing device may include a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage device or storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions or modules described may be implemented in hardware, software, firmware, or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the aspects or features described herein. Various modifications to these embodiments will be readily apparent to those skilled in the art, and the generic principles defined herein may be applied to other embodiments without departing from the spirit or scope of the aspects or features described herein. Thus, the aspects or features described herein are not intended to be limited to the embodiments shown herein but is to be accorded the widest scope consistent with the principles and novel features disclosed herein.

What is claimed is:

1. A method for positioning system enhancement, the method comprising:
receiving a visible light communication (VLC) signal at a mobile device;
decoding an identifier from the received VLC signal;
determining a position of the mobile device relative to a source of the VLC signal;
measuring an external field in response to receiving the VLC signal, wherein the external field is at least one of magnetic or electromagnetic, and wherein the external field measurement is associated with the position of the mobile device; and
sending information to a server, wherein the information comprises the identifier, the position, and the external field measurement associated with the position of the mobile device.

2. The method of claim 1, further comprising:
receiving a heatmap updated according to the sent identifier, position, and external field measurement associated with the position of the mobile device.

3. The method of claim 1, wherein the external field measurement comprises at least one of: received radio frequency (RF) signal power level, RF signal path time delay, RF signal delay spread, RF signal frequency, ambient magnetic field strength, or any combination thereof.

4. The method of claim 1, wherein the external field comprises one of: an RF signal transmitted from the mobile device to a wireless access point, an RF signal received at the mobile device, or an RF signal received from a Bluetooth transmitter.

5. The method of claim 1, further comprising:
receiving a request to initiate VLC signal positioning and measure the external field at the mobile device, wherein the request is in response to at least one of: time expired since configuring the positioning parameter, relocation or addition of a wireless access point, relocation or addition of a Bluetooth device, change in physical layout of a venue, or any combination thereof.

6. A mobile device configured for positioning system enhancement, the mobile device comprising:
a processor;
a storage device coupled to the processor and configurable for storing instructions, which, when executed by the processor, cause the processor to:
receive a visible light communication (VLC) signal at a mobile device;
decode an identifier from the received VLC signal;
determine a position of the mobile device relative to a source of the VLC signal;
measure an external field in response to receiving the VLC signal, wherein the external field is at least one of magnetic or electromagnetic, and wherein the external field measurement is associated with the position of the mobile device; and
send information to a server, wherein the information comprises the identifier, the position, and the external field measurement associated with the position of the mobile device.

7. The device of claim 6, further comprising instructions to:
receive a heatmap updated according to the sent identifier, position, and external field measurement associated with the position of the mobile device.

8. The device of claim 6, wherein the external field measurement comprises at least one of: received radio frequency (RF) signal power level, RF signal path time delay, RF signal delay spread, RF signal frequency, ambient magnetic field strength, or any combination thereof.

9. The device of claim 6, wherein the external field comprises one of: an RF signal transmitted from the mobile device to a wireless access point, an RF signal received at the mobile device, or an RF signal received from a Bluetooth transmitter.

10. The device of claim 6, further comprising instructions to:
receive a request to initiate VLC signal positioning and measure the external field at the mobile device, wherein the request is in response to at least one of: time expired since configuring the positioning parameter, relocation or addition of a wireless access point, relocation or addition of a Bluetooth device, change in physical layout of a venue, or any combination thereof.

11. A method for updating a heatmap at a server, the method comprising:
receiving a position of a mobile device relative to a source of a visible light communication (VLC) signal;
receiving, from the mobile device, an identifier for the source of the VLC signal;
receiving an external field measurement captured at the position of the mobile device relative to the source of the VLC signal, wherein the external field is at least one of magnetic or electromagnetic;
identifying a position in the heatmap according to the identifier for the source of the VLC signal and the position of the mobile device relative to the source of the VLC signal; and
updating, according to the received the external field measurement, one or more positioning parameters associated with the identified position in the heatmap.

12. The method of claim 11, wherein the external field measurement comprises at least one of: received radio frequency (RF) signal power level, RF signal path time delay, RF signal delay spread, RF signal frequency, ambient magnetic field strength, or any combination thereof.

13. The method of claim 11, wherein the one or more positioning parameters comprises at least one of: statistics of a received RF signal power at the mobile device's position, path loss, tap delay, wall loss, diffraction, body loss, transmission power of the RF signal source, statistics of an ambient magnetic field strength at the mobile device's location, or any combination thereof.

14. The method of claim 11, wherein the external field comprises an RF signal transmitted from the mobile device to a wireless access point, received at the mobile device, or received from a Bluetooth transmitter.

15. The method of claim 11, further comprising:
sending a request to initiate VLC signal positioning and measure the external field at the mobile device, wherein the request is triggered in response to at least one of: time expired since configuring the positioning parameter, relocation or addition of a wireless access point, relocation or addition of a Bluetooth device, change in physical layout of a venue, or any combination thereof.

16. A server configured for updating a heatmap, the server comprising:
a processor;
a storage device coupled to the processor and configurable for storing instructions, which, when executed by the processor, cause the processor to:
receive a position of a mobile device relative to a source of a visible light communication (VLC) signal;
receive, from the mobile device, an identifier for the source of the VLC signal;
receive an external field measurement captured at the position of the mobile device relative to the source of the VLC signal, wherein the external field is at least one of magnetic or electromagnetic;
identify a position in the heatmap according to the identifier for the source of the VLC signal and the position of the mobile device relative to the source of the VLC signal; and
update, according to the received the external field measurement, one or more positioning parameters associated with the identified position in the heatmap.

17. The server of claim 16, wherein the external field measurement comprises at least one of: received radio frequency (RF) signal power level, RF signal path time delay, RF signal delay spread, RF signal frequency, ambient magnetic field strength, or any combination thereof.

18. The server of claim 16, wherein the one or more positioning parameters comprises at least one of: statistics of a received RF signal power at the mobile device's position, path loss, tap delay, wall loss, diffraction, body loss, transmission power of the RF signal source, statistics of an ambient magnetic field strength at the mobile device's location, or any combination thereof.

19. The server of claim 16, wherein the external field comprises a RF signal transmitted from the mobile device to a wireless access point, received at the mobile device, or received from a Bluetooth transmitter.

20. The server of claim 16, further comprising instructions to:
send a request to initiate VLC signal positioning and measure the external field at the mobile device, wherein the request is triggered in response to at least one of: time expired since configuring the positioning parameter, relocation or addition of a wireless access point, relocation or addition of a Bluetooth device, change in physical layout of a venue, or any combination thereof.
